(19) United States
(12) Patent Application Publication
(10) Pub. No.: US 2026/0202990 A1
(43) Pub. Date: Jul. 16, 2026

(54) CROSS MEMORY PLANE DATA BUFFER TRANSFER

(71) Applicant: Micron Technology, Inc., Boise, ID (US)

(72) Inventors: Wei Lic Chew, Singapore (SG); Satoru Tamada, Singapore (SG); En Sheng Lee, Singapore (SG); Chee Kheng Lim, Singapore (SG)

(21) Appl. No.: 19/416,558

(22) Filed: Dec. 11, 2025

Related U.S. Application Data
(60) Provisional application No. 63/744,614, filed on Jan. 13, 2025.

(51) Int. Cl. G06F 3/06

(52) U.S. Cl. CPC G06F 3/0656; G06F 3/0604; G06F 3/0679

(57) ABSTRACT

Control logic in a memory device executes a read operation of at least a portion of first data stored in a first page buffer associated with a first memory plane of a plurality of memory planes of the memory device. A write operation is executed to cause second data associated with the at least the portion of the first data to be written to a second page buffer of the memory device.

### CROSS-REFERENCE TO RELATED APPLICATION

This application claims the benefit of U.S. Provisional Application No. 63/744,614, titled “Cross Memory Plane Data Buffer Transfer”, filed January 13, 2025, the entire contents of which are hereby incorporated by reference herein.

### TECHNICAL FIELD

Embodiments of the disclosure relate generally to memory sub-systems, and more specifically, relate to control logic of a memory device that is configured to transfer data from a first page buffer associated with a first memory plane of a set of memory planes of a memory device to a second page buffer associated with a second memory plane of the set of memory planes of the memory device.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1A illustrates an example computing system that includes a memory sub-system, in accordance with one or more embodiments of the present disclosure.

FIG. 1B is a block diagram of a memory device in communication with a memory sub-system controller of a memory sub-system, in accordance with one or more embodiments of the present disclosure.

FIGS. 2A-2D are schematics of portions of an array of memory cells as could be used in a memory of the type described with reference to FIG. 1B, in accordance with one or more embodiments of the present disclosure.

FIG. 3 is a block schematic of a portion of an array of memory cells as could be used in a memory of the type described with reference to FIG. 1B, in accordance with one or more embodiments of the present disclosure.

FIG. 4 illustrates an example memory device including a page buffer manager configured to manage the transfer of data associated with a first page buffer associated with a first memory plane to a second page buffer associated with a second memory of a multi-plane memory device, in accordance with one or more embodiments of the present disclosure.

FIG. 5 illustrates an example memory device including a page buffer manager configured to manage the transfer of a copy of “good” or non-corrupted read-only memory (ROM) data from a page buffer associated with a memory block of a ROM backup plane memory block of a ROM data backup plane to a page buffer associated with a memory block of a plane that is the source of corrupt ROM data, in accordance with one or more embodiments of the present disclosure.

FIG. 6 illustrates an example memory device including a page buffer manager configured to manage the transfer of one or more copies of test data generated by automated test equipment from a first page buffer to one or more other page buffers, in accordance with one or more embodiments of the present disclosure.

FIG. 7 illustrates an example memory device including a page buffer manager configured to manage the transfer of error correction data generated by an error correction algorithm from one or more page buffers to one or more other page buffers of the memory device, in accordance with one or more embodiments of the present disclosure.

FIG. 8 is a flow diagram of an example method of transferring data from a first page buffer associated with a first memory plane of a set of memory planes of a memory device to a second page buffer associated with a second memory plane of the set of memory planes of the memory device, in accordance with one or more embodiments of the present disclosure.

FIG. 9 is a block diagram of an example computer system in which embodiments of the present disclosure can operate.

### DETAILED DESCRIPTION

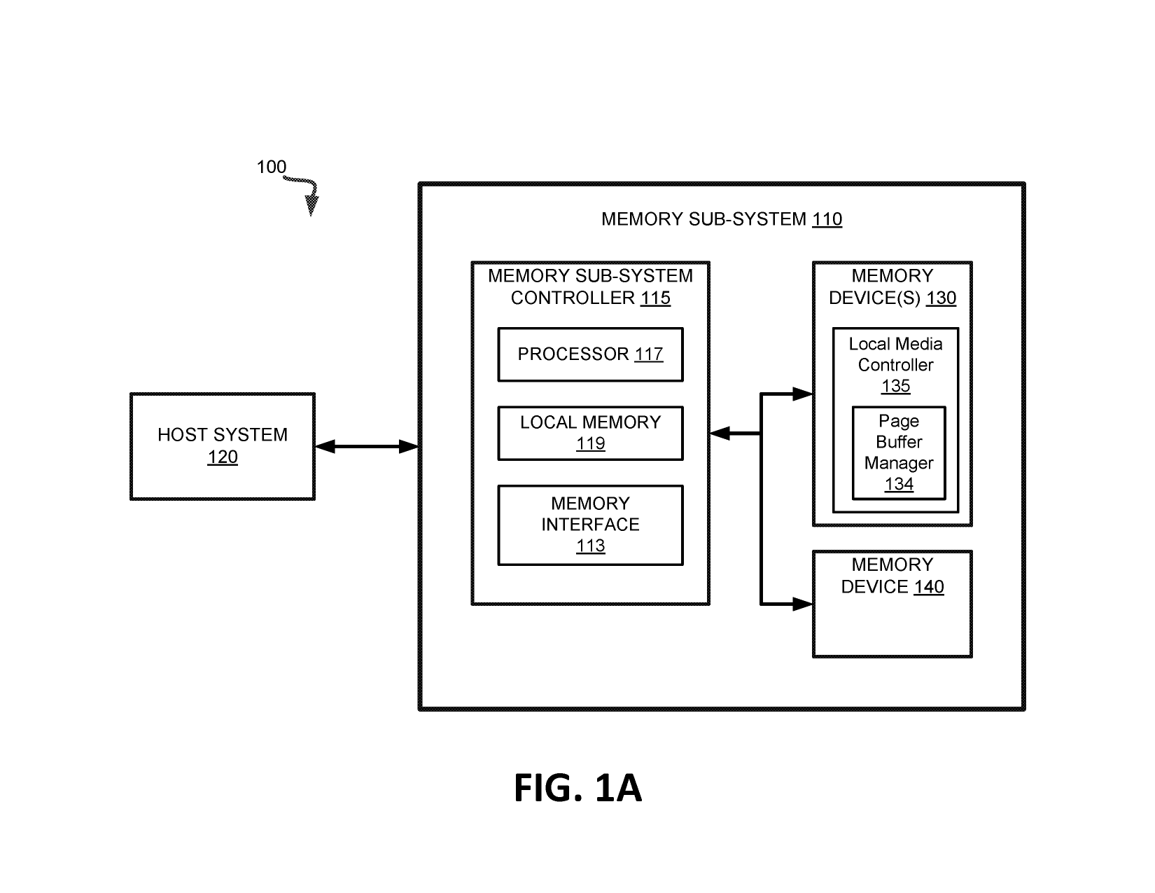

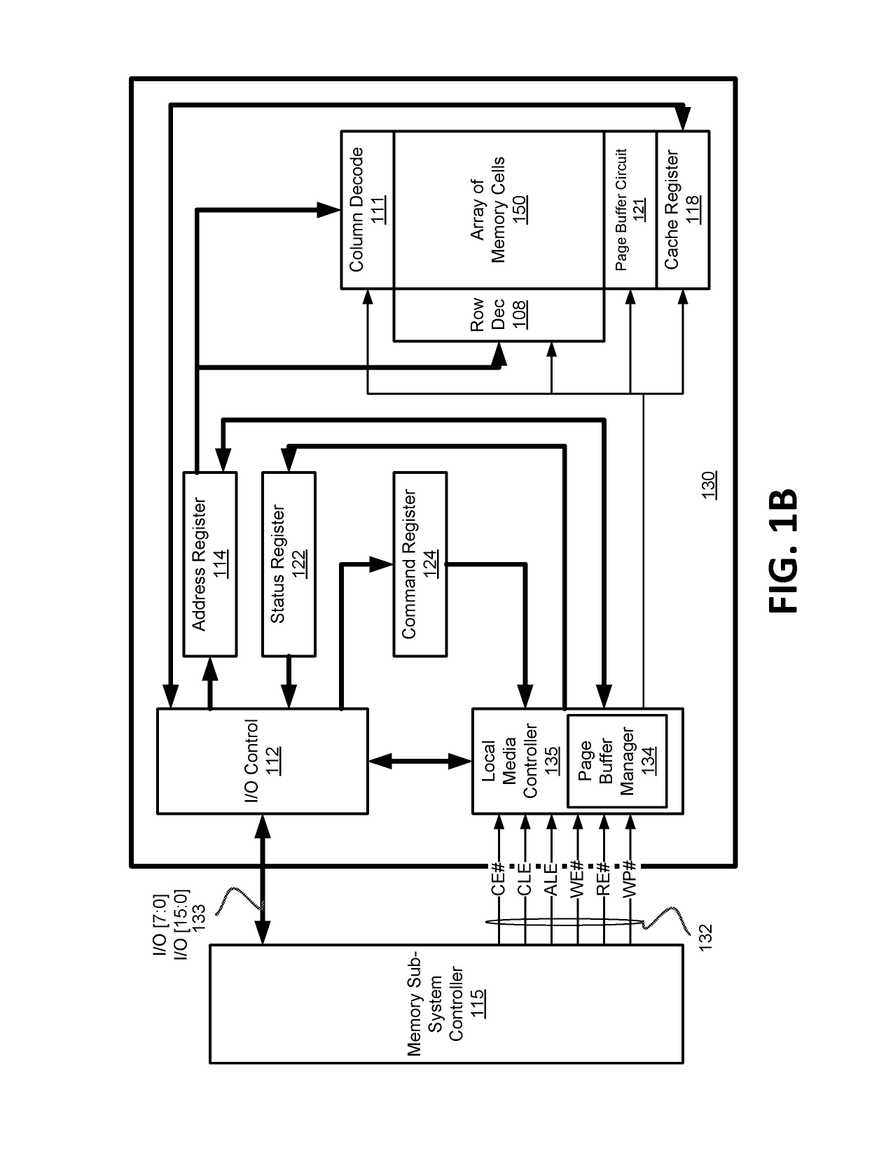

Aspects of the present disclosure are directed to control logic of a memory device that is configured to transfer data from a first page buffer associated with a first memory plane of a set of memory planes of the memory device to a second page buffer associated with a second memory plane of the set of memory planes of the memory device. A memory sub-system can be a storage device, a memory module, or a hybrid of a storage device and memory module. Examples of storage devices and memory modules are described below in conjunction with FIG. 1A. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a negative-and (NAND) memory device. Other examples of non-volatile memory devices are described below in conjunction with FIG. 1A. A non-volatile memory device is a package of one or more dies. Each die can consist of one or more planes. For some types of non-volatile memory devices (e.g., NAND devices), each plane consists of a set of physical blocks. Each block consists of a set of pages. Each page consists of a set of memory cells ("cells"). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

Memory cells are formed on a silicon wafer in an array of columns (also hereinafter referred to as “bitlines”) and rows (also hereinafter referred to as wordlines). A wordline can refer to one or more rows of memory cells of a memory device that are used with one or more bitlines to generate the address of each of the memory cells. The intersection of a bitline and wordline constitutes the address of the memory cell.

A block hereinafter refers to a unit of the memory device used to store data and can include a group of memory cells, a wordline group, a wordline, or individual memory cells. Each block can include a number of sub-blocks, where each sub-block is defined by an associated pillar (e.g., a vertical conductive trace) extending from a shared bitline. Memory pages (also referred to herein as “pages”) store one or more bits of binary data corresponding to data received from the host system. To achieve high density, a string of memory cells in a non-volatile memory device can be constructed to include a number of memory cells at least partially surrounding a pillar of poly-silicon channel material (i.e., a channel region). The memory cells can be coupled to access lines (i.e., wordlines) often fabricated in common with the memory cells, so as to form an array of strings in a block of memory (e.g., a memory array). The compact nature of certain non-volatile memory devices, such as 3D flash NAND memory, means wordlines are common to many memory cells within a block of memory. Some memory devices use certain types of memory cells, such as triple-level cell (TLC) memory cells, which store three bits of data in each memory cell, which make it affordable to move more applications from legacy hard disk drives to newer memory sub-systems, such as NAND solid-state drives (SSDs).

Typical memory device architecture allows for page data associated with a program operation to be stored in separate individual data buffers (e.g., page buffers) on a plane-by-plane basis. To improve reliability and performance, it may be desirable to transfer page data from blocks of one plane to another plane, without relying on an externally-managed method of recording page data associated with a read operation (e.g., using a memory sub-system controller and/or using volatile memory (e.g., dynamic random access memory (DRAM)) and rewriting the page data back to another memory plane in the multi-plane memory device.

However, due to the aforementioned plane restriction, page data associated with a memory block of a memory plane is stored only in that memory plane. In this regard, in a multi-plane memory device, data to be written to a memory page of a target memory block of a target memory plane is stored in a particular page buffer associated with that target memory plane.

In some systems, a memory device copyback program operation may be used to read data stored in a page buffer associated with a memory plane and write that data to another memory block within the same memory plane. Accordingly, the use of a copyback program operation similarly restricts the user to program data stored in the data buffer of the memory plane to another memory block in the same memory plane, and does not enable the transfer of data from one memory plane to another memory plane.

According to aspects of the present disclosure, cross-plane data buffer transfer is enabled by control logic within a multi-plane memory device (e.g., a local media controller). According to embodiments, control logic of the memory device manages the transfer of data from a first page buffer associated with a first memory plane (i.e., a first plane page buffer) of the multi-plane memory device to a second page buffer associated with a second memory plane (i.e., a second plane page buffer) of the multi-plane memory device.

According to embodiments, the control logic of the memory device can cause execution of a read operation to read first data from a first plane page buffer and store the read data in a temporary buffer (e.g., a static random-access memory (SRAM) buffer) of the memory device. According to embodiments, a write operation may be executed to write second data (i.e., data associated with the first data) from the temporary buffer (e.g., SRAM buffer) to another plane page buffer (e.g., a second page buffer associated with a second memory plane).

In an embodiment, the control logic manages a cross-plane data backup process to identify generate and store a copy of first data (stored in a first plane page buffer) to a second plane page buffer. In this embodiment, the copy of the first data stored in the second plane page buffer can be written to a target memory block of the second memory plane.

In an embodiment, the control logic identifies a “bad” nonvolatile memory block (e.g., a read only memory (ROM) block that includes corrupted data). For example, during a power-up process of the memory device, data stored in a ROM memory block (e.g., a first ROM block) of a memory plane (e.g., a first plane) is retrieved and stored in a corresponding plane page buffer (e.g., a first plane page buffer). In an embodiment, the control logic may determine that the data stored in the first ROM block is corrupted and cannot be used for the power-up process. In response, the control logic can cause a back-up ROM block (e.g., a second ROM block) of a different memory plane (e.g., a second plane) to store “good” copies of the corrupted data in a corresponding plane page buffer (e.g., a second plane page buffer) and transfer the good (non-corrupted data) from the second plane page buffer to the first plane page buffer using the temporary buffer (e.g., SRAM buffer) of the memory device. Advantageously, the cross-plane transfer of the good data from the second plane page buffer to the first plane page buffer enables the memory device power-up process to be executed reliably.

In an embodiment, the control logic of the memory device can cause the transfer of a copy of test data (e.g., data generated by automated test equipment) from a first plane page buffer to one or more other plane page buffers (e.g., a second plane page buffer, a third plane page buffer… an Nth plane page buffer). Advantageously, the cross plane page buffer transfer of a test data copy from a first plane page buffer to one or more additional plane page buffer avoids the need to execute multiple rewrites of the test data to the additional plane page buffers, which results in a total test time reduction.

In an embodiment, the control logic of the memory device can enable the transferring of error correction data and recovered data across multiple plane page buffers. In an embodiment, an error correction algorithm (e.g., an error correction code (ECC) algorithm) can be performed to generate recovered data associated with a memory device. The recovered data can be stored in a first plane page buffer associated with a critical memory block of the memory device. Advantageously, additional error correction-related data can be stored in a second plane page buffer (i.e., a page buffer associated with a memory plane that is not associated with the critical block). The recovered data of the first plane page buffer and the additional error correction-related data can be transferred or shared between the first plane page buffer and the second plane page buffer. The use of multiple plane page buffers to store and transfer error correction-related data enables the execution of more complex and sophisticated error correction algorithms, since additional page buffers can be used to store further error correction-related data and transfer the data between the multiple page buffers for error correction purposes.

FIG. 1A illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1A illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, compute express link (CXL) interface). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a CXL interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1A illustrates a memory sub-system 110 as an example. In general, the host system 120 can access multiple memory sub-systems via a same communication connection, multiple separate communication connections, and/or a combination of communication connections.

The memory devices 130,140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include negative-and (NAND) type flash memory and write-in-place memory, such as a three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks. In one embodiment, the term “MLC memory” can be used to represent any type of memory cell that stores more than one bit per cell (e.g., 2 bits, 3 bits, 4 bits, or 5 bits per cell).

Although non-volatile memory components such as 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can be a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1A has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which includes a raw memory device 130 having control logic (e.g., local media controller 135) on the die and a controller (e.g., memory sub-system controller 115) for media management within the same memory device package. An example of a managed memory device is a managed NAND (MNAND) device.

In one embodiment, the memory sub-system 110 includes a memory interface component 113. Memory interface component 113 is responsible for handling interactions of memory sub-system controller 115 with the memory devices of memory sub-system 110, such as memory device 130. For example, memory interface component 113 can send memory access commands corresponding to requests received from host system 120 to memory device 130, such as program commands, read commands, or other commands. In addition, memory interface component 113 can receive data from memory device 130, such as data retrieved in response to a read command or a confirmation that a program command was successfully performed. For example, the memory sub-system controller 115 can include a processor 117 (processing device) configured to execute instructions stored in local memory 119 for performing the operations described herein.

In one embodiment, memory device 130 includes a page buffer manager 134 configured to transfer data from a first page buffer associated with a first memory plane of a set of memory planes of a memory device to a second page buffer associated with a second memory plane of the set of memory planes of the memory device, according to embodiments of the present disclosure. Further details with regards to the operations of page buffer manager 134 are described below.

FIG. 1B is a simplified block diagram of a first apparatus, in the form of a memory device 130, in communication with a second apparatus, in the form of a memory sub-system controller 115 of a memory sub-system (e.g., memory sub-system 110 of FIG. 1A), according to an embodiment. Some examples of electronic systems include personal computers, personal digital assistants (PDAs), digital cameras, digital media players, digital recorders, games, appliances, vehicles, wireless devices, mobile telephones and the like. The memory sub-system controller 115 (e.g., a controller external to the memory device 130), may be a memory controller or other external host device.

Memory device 130 includes an array of memory cells 150 logically arranged in rows and columns. Memory cells of a logical row are typically connected to the same access line (e.g., a wordline) while memory cells of a logical column are typically selectively connected to the same data line (e.g., a bitline). A single access line may be associated with more than one logical row of memory cells and a single data line may be associated with more than one logical column. Memory cells (not shown in FIG. 1B) of at least a portion of array of memory cells 250 are capable of being programmed to one of at least two target data states.

Row decode circuitry 108 and column decode circuitry 111 are provided to decode address signals. Address signals are received and decoded to access the array of memory cells 150. Memory device 130 also includes input/output (I/O) control circuitry 112 to manage input of commands, addresses and data to the memory device 130 as well as output of data and status information from the memory device 130. An address register 114 is in communication with I/O control circuitry 212 and row decode circuitry 108 and column decode circuitry 111 to latch the address signals prior to decoding. A command register 124 is in communication with I/O control circuitry 112 and local media controller 135 to latch incoming commands.

A controller (e.g., the local media controller 135 internal to the memory device 130) controls access to the array of memory cells 150 in response to the commands and generates status information for the external memory sub-system controller 115, i.e., the local media controller 135 is configured to perform access operations (e.g., read operations, programming operations and/or erase operations) on the array of memory cells 150. The local media controller 135 is in communication with row decode circuitry 108 and column decode circuitry 111 to control the row decode circuitry 108 and column decode circuitry 111 in response to the addresses. In one embodiment, local media controller 135 includes page buffer manager 134, which can cause execution of ganged memory access operations (i.e., memory access operations associated with multiple selected pages using a set of multiple sense modules coupled to a page buffer circuit via a global bitline, where each sense module is coupled to a sub-set of multiple pillars, as described herein.

The local media controller 135 is also in communication with a cache register 118. Cache register 118 latches data, either incoming or outgoing, as directed by the local media controller 135 to temporarily store data while the array of memory cells 150 is busy writing or reading, respectively, other data. During a program operation (e.g., write operation), data may be passed from the cache register 118 to a page buffer circuit (or data register) 121 for transfer to the array of memory cells 150; then new data may be latched in the cache register 118 from the I/O control circuitry 112. During a read operation, data may be passed from the cache register 118 to the I/O control circuitry 112 for output to the memory sub-system controller 115; then new data may be passed from the page buffer circuit 121 to the cache register 118. The cache register 118 and/or the page buffer circuit 121 may form (e.g., may form a portion of) a page buffer of the memory device 130. The page buffer circuit 121 may further include sensing devices (not shown in FIG. 1B) to sense a data state of a memory cell of the array of memory cells 150, e.g., by sensing a state of a data line connected to that memory cell. A status register 122 may be in communication with I/O control circuitry 112 and the local memory controller 135 to latch the status information for output to the memory sub-system controller 115.

Memory device 130 receives control signals at the memory sub-system controller 115 from the local media controller 135 over a control link 132. For example, the control signals can include a chip enable signal CE#, a command latch enable signal CLE, an address latch enable signal ALE, a write enable signal WE#, a read enable signal RE#, and a write protect signal WP#. Additional or alternative control signals (not shown) may be further received over control link 132 depending upon the nature of the memory device 130. In one embodiment, memory device 130 receives command signals (which represent commands), address signals (which represent addresses), and data signals (which represent data) from the memory sub-system controller 115 over a multiplexed input/output (I/O) bus 133 and outputs data to the memory sub-system controller 115 over I/O bus 133.

For example, the commands may be received over input/output (I/O) pins [7:0] of I/O bus 133 at I/O control circuitry 112 and may then be written into command register 124. The addresses may be received over input/output (I/O) pins [7:0] of I/O bus 234 at I/O control circuitry 112 and may then be written into address register 114. The data may be received over input/output (I/O) pins [7:0] for an 8-bit device or input/output (I/O) pins [15:0] for a 16-bit device at I/O control circuitry 112 and then may be written into cache register 118. The data may be subsequently written into page buffer circuit 121 for programming the array of memory cells 150.

In an embodiment, cache register 118 may be omitted, and the data may be written directly into page buffer circuit 121. Data may also be output over input/output (I/O) pins [7:0] for an 8-bit device or input/output (I/O) pins [15:0] for a 16-bit device. Although reference may be made to I/O pins, they may include any conductive node providing for electrical connection to the memory device 130 by an external device (e.g., the memory sub-system controller 115), such as conductive pads or conductive bumps as are commonly used.

It will be appreciated by those skilled in the art that additional circuitry and signals can be provided, and that the memory device 130 of FIG. 1B has been simplified. It should be recognized that the functionality of the various block components described with reference to FIG. 1B may not necessarily be segregated to distinct components or component portions of an integrated circuit device. For example, a single component or component portion of an integrated circuit device could be adapted to perform the functionality of more than one block component of FIG. 1B. Alternatively, one or more components or component portions of an integrated circuit device could be combined to perform the functionality of a single block component of FIG. 1B. Additionally, while specific I/O pins are described in accordance with popular conventions for receipt and output of the various signals, it is noted that other combinations or numbers of I/O pins (or other I/O node structures) may be used in the various embodiments.

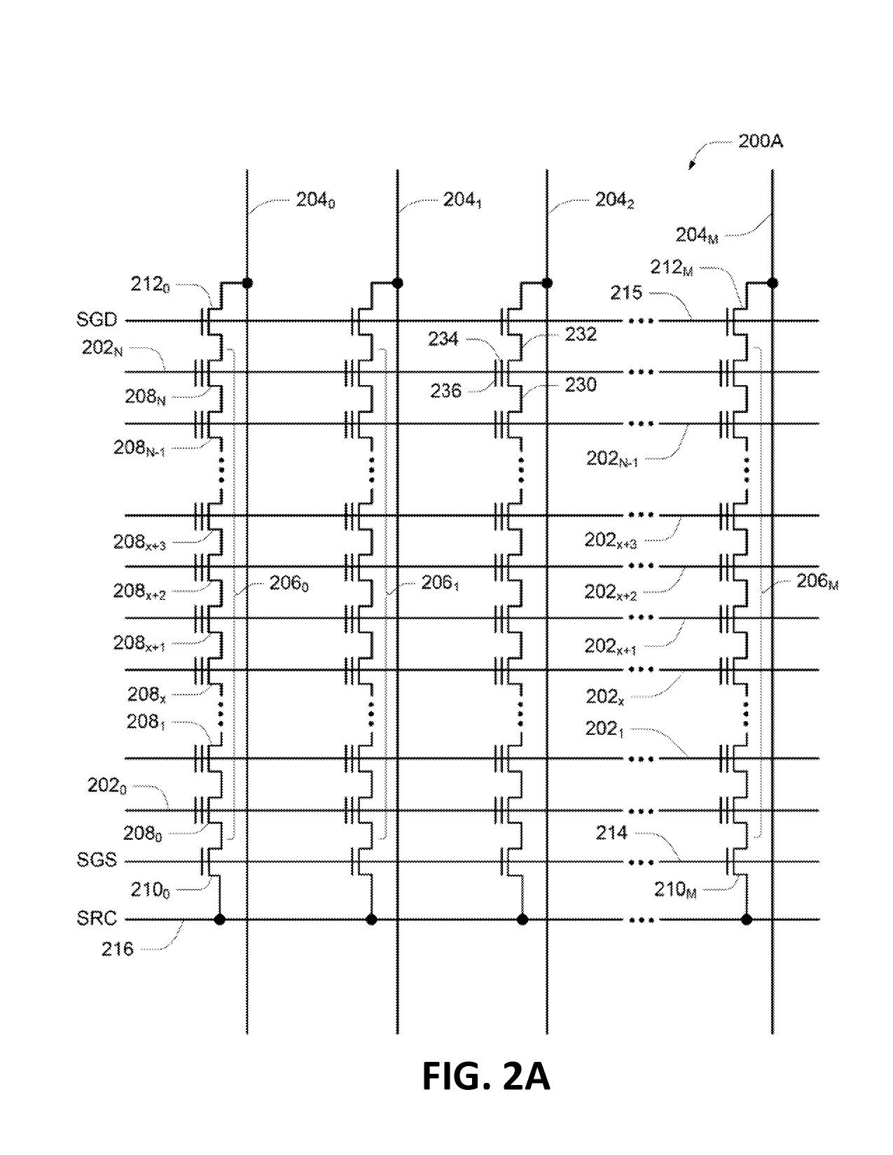

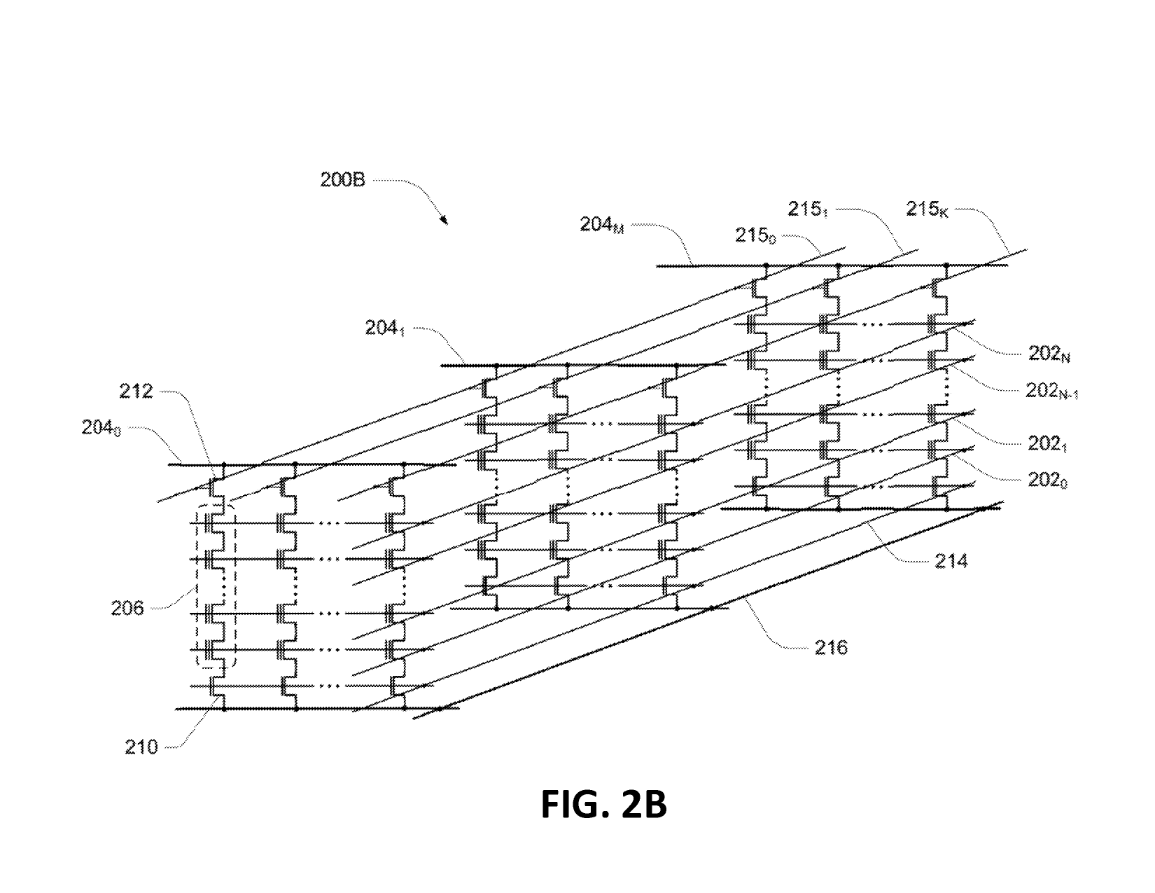

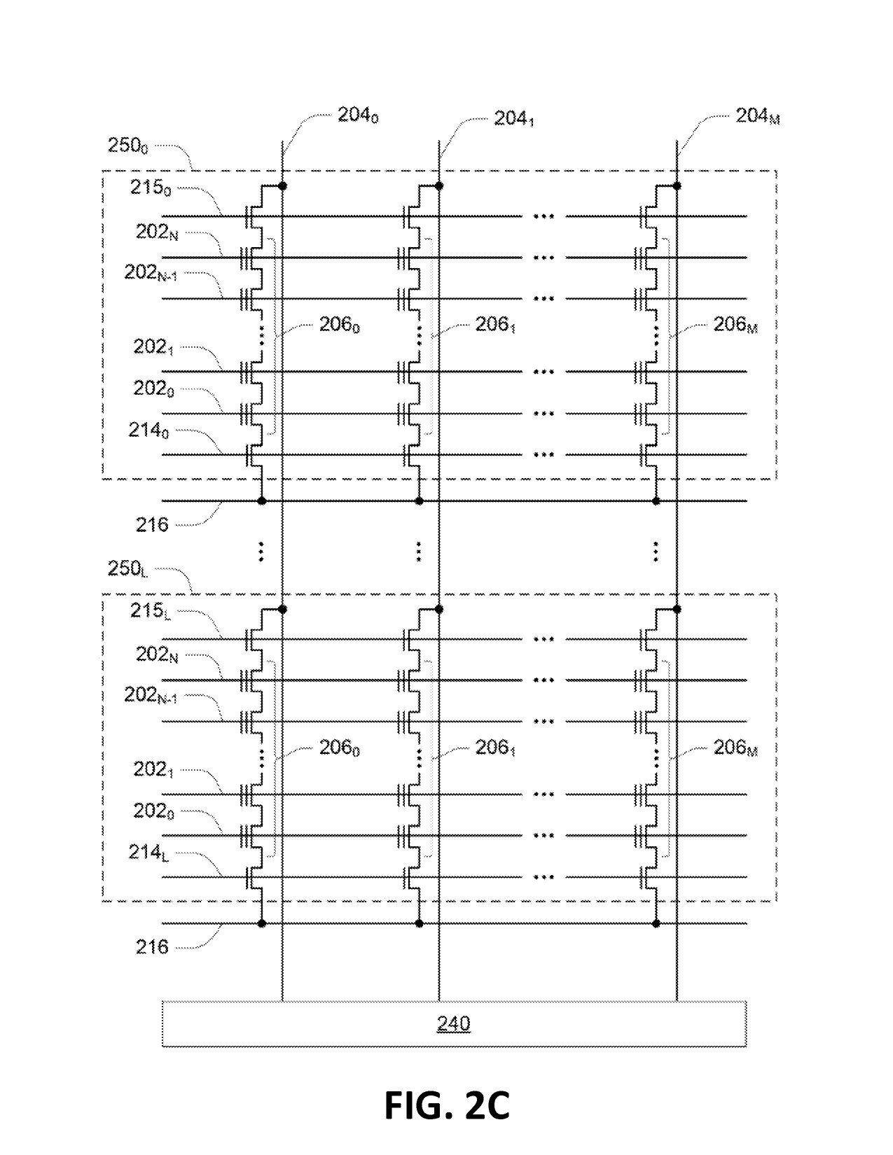

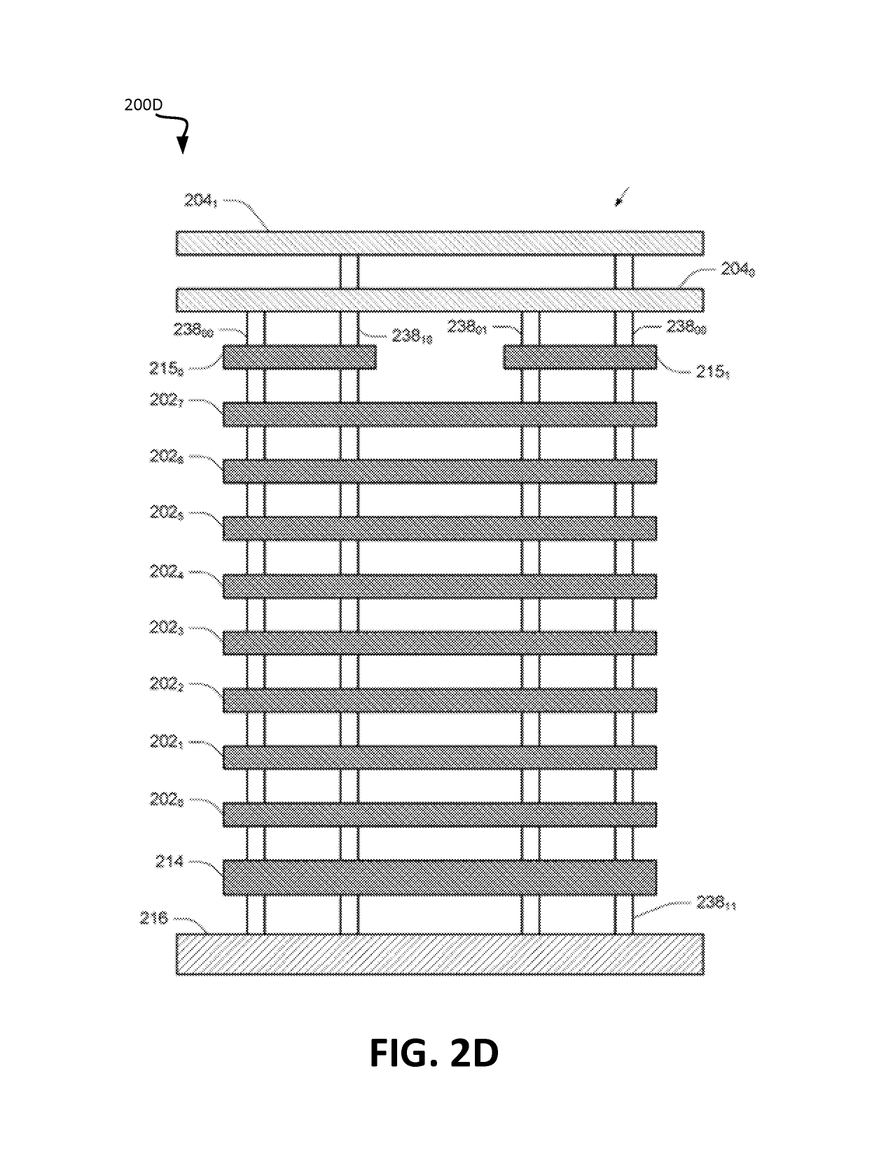

FIG. 2A-2C are schematics of portions of an array of memory cells 200A, such as a NAND memory array, as could be used in a memory of the type described with reference to FIG. 1B according to an embodiment, e.g., as a portion of the array of memory cells 104. Memory array 200A includes access lines, such as wordlines 202₀to 202_{N}, and data lines, such as bitlines 204₀to 204_{M}. The wordlines 202 can be connected to global access lines (e.g., global wordlines), not shown in FIG. 2A, in a many-to-one relationship. For some embodiments, memory array 200A can be formed over a semiconductor that, for example, can be conductively doped to have a conductivity type, such as a p-type conductivity, e.g., to form a p-well, or an n-type conductivity, e.g., to form an n-well.

Memory array 200A can be arranged in rows (each corresponding to a wordline 202) and columns (each corresponding to a bitline 204). Each column can include a string of series-connected memory cells (e.g., non-volatile memory cells), such as one of NAND strings 206₀to 206_{M}. Each NAND string 206 can be connected (e.g., selectively connected) to a common source (SRC) 216 and can include memory cells 208₀to 208_{N}. The memory cells 208 can represent non-volatile memory cells for storage of data. The memory cells 208 of each NAND string 206 can be connected in series between a select gate 210 (e.g., a field-effect transistor), such as one of the select gates 210₀to 210_{M} (e.g., that can be source select transistors, commonly referred to as select gate source), and a select gate 212 (e.g., a field-effect transistor), such as one of the select gates 212₀to 212_{M} (e.g., that can be drain select transistors, commonly referred to as select gate drain). Select gates 210₀to 210_{M} can be commonly connected to a select line 214, such as a source select line (SGS), and select gates 212₀to 212_{M} can be commonly connected to a select line 215, such as a drain select line (SGD). Although depicted as traditional field-effect transistors, the select gates 210 and 212 can utilize a structure similar to (e.g., the same as) the memory cells 208. The select gates 210 and 212 can represent a number of select gates connected in series, with each select gate in series configured to receive a same or independent control signal.

A source of each select gate 210 can be connected to common source 216. The drain of each select gate 210 can be connected to a memory cell 208₀of the corresponding NAND string 206. For example, the drain of select gate 210₀can be connected to memory cell 208₀of the corresponding NAND string 206₀. Therefore, each select gate 210 can be configured to selectively connect a corresponding NAND string 206 to the common source 216. A control gate of each select gate 210 can be connected to the select line 214.

The drain of each select gate 212 can be connected to the bitline 204 for the corresponding NAND string 206. For example, the drain of select gate 212₀can be connected to the bitline 204₀for the corresponding NAND string 206₀. The source of each select gate 212 can be connected to a memory cell 208_{N} of the corresponding NAND string 206. For example, the source of select gate 212₀can be connected to memory cell 208_{N} of the corresponding NAND string 206₀. Therefore, each select gate 212 can be configured to selectively connect a corresponding NAND string 206 to the corresponding bitline 204. A control gate of each select gate 212 can be connected to select line 215.

The memory array 200A in FIG. 2A can be a quasi-two-dimensional memory array and can have a generally planar structure, e.g., where the common source 216, NAND strings 206 and bitlines 204 extend in substantially parallel planes. Alternatively, the memory array 200A in FIG. 2A can be a three-dimensional memory array, e.g., where NAND strings 206 can extend substantially perpendicular to a plane containing the common source 216 and to a plane containing the bitlines 204 that can be substantially parallel to the plane containing the common source 216.

Typical construction of memory cells 208 includes a data-storage structure 234 (e.g., a floating gate, charge trap, and the like) that can determine a data state of the memory cell (e.g., through changes in threshold voltage), and a control gate 236, as shown in FIG. 2A. The data-storage structure 234 can include both conductive and dielectric structures while the control gate 236 is generally formed of one or more conductive materials. In some cases, memory cells 208 can further have a defined source/drain (e.g., source) 230 and a defined source/drain (e.g., drain) 232. The memory cells 208 have their control gates 236 connected to (and in some cases form) a wordline 202.

A column of the memory cells 208 can be a NAND string 206 or a number of NAND strings 206 selectively connected to a given bitline 204. A row of the memory cells 208 can be memory cells 208 commonly connected to a given wordline 202. A row of memory cells 208 can, but need not, include all the memory cells 208 commonly connected to a given wordline 202. Rows of the memory cells 208 can often be divided into one or more groups of physical pages of memory cells 208, and physical pages of the memory cells 208 often include every other memory cell 208 commonly connected to a given wordline 202. For example, the memory cells 208 commonly connected to wordline 202_{N} and selectively connected to even bitlines 204 (e.g., bitlines 204₀, 204₂, 204₄, etc.) can be one physical page of the memory cells 208 (e.g., even memory cells) while memory cells 208 commonly connected to wordline 202_{N} and selectively connected to odd bitlines 204 (e.g., bitlines 204₁, 204₃, 204₅, etc.) can be another physical page of the memory cells 208 (e.g., odd memory cells).

Although bitlines 204₃-204₅are not explicitly depicted in FIG. 2A, it is apparent from the figure that the bitlines 204 of the array of memory cells 200A can be numbered consecutively from bitline 204₀to bitline 204_{M}. Other groupings of the memory cells 208 commonly connected to a given wordline 202 can also define a physical page of memory cells 208. For certain memory devices, all memory cells commonly connected to a given wordline can be deemed a physical page of memory cells. The portion of a physical page of memory cells (which, in some embodiments, could still be the entire row) that is read during a single read operation or programmed during a single programming operation (e.g., an upper or lower page of memory cells) can be deemed a logical page of memory cells. A block of memory cells can include those memory cells that are configured to be erased together, such as all memory cells connected to wordlines 202₀-202_{N} (e.g., all NAND strings 206 sharing common wordlines 202). Unless expressly distinguished, a reference to a page of memory cells herein refers to the memory cells of a logical page of memory cells. Although the example of FIG. 2A is discussed in conjunction with NAND flash, the embodiments and concepts described herein are not limited to a particular array architecture or structure, and can include other structures (e.g., SONOS, phase change, ferroelectric, etc.) and other architectures (e.g., AND arrays, NOR arrays, etc.).

FIG. 2B is another schematic of a portion of an array of memory cells 200B as could be used in a memory of the type described with reference to FIG. 1B, e.g., as a portion of the array of memory cells 104. Like numbered elements in FIG. 2B correspond to the description as provided with respect to FIG. 2A. FIG. 2B provides additional detail of one example of a three-dimensional NAND memory array structure. The three-dimensional NAND memory array 200B can incorporate vertical structures which can include semiconductor pillars where a portion of a pillar can act as a channel region of the memory cells of NAND strings 206. The NAND strings 206 can be each selectively connected to a bitline 204₀-204_{M} by a select transistor 212 (e.g., that can be drain select transistors, commonly referred to as select gate drain) and to a common source 216 by a select transistor 210 (e.g., that can be source select transistors, commonly referred to as select gate source). Multiple NAND strings 206 can be selectively connected to the same bitline 204. Subsets of NAND strings 206 can be connected to their respective bitlines 204 by biasing the select lines 215₀-215_{K} to selectively activate particular select transistors 212 each between a NAND string 206 and a bitline 204. The select transistors 210 can be activated by biasing the select line 214. Each wordline 202 can be connected to multiple rows of memory cells of the memory array 200B. Rows of memory cells that are commonly connected to each other by a particular wordline 202 can collectively be referred to as tiers.

FIG. 2C is a further schematic of a portion of an array of memory cells 200C as could be used in a memory of the type described with reference to FIG. 1B, e.g., as a portion of the array of memory cells 104. Like numbered elements in FIG. 2C correspond to the description as provided with respect to FIG. 2A. The array of memory cells 200C can include strings of series-connected memory cells (e.g., NAND strings) 206, access (e.g., word) lines 202, data (e.g., bit) lines 204, select lines 214 (e.g., source select lines), select lines 215 (e.g., drain select lines) and a source 216 as depicted in FIG. 2A. A portion of the array of memory cells 200A can be a portion of the array of memory cells 200C, for example.

FIG. 2C depicts groupings of NAND strings 206 into blocks of memory cells 250, e.g., blocks of memory cells 250₀-250_{L}. Blocks of memory cells 250 can be groupings of memory cells 208 that can be erased together in a single erase operation, sometimes referred to as erase blocks. Each block of memory cells 250 can represent those NAND strings 206 commonly associated with a single select line 215, e.g., select line 215₀. The source 216 for the block of memory cells 250₀can be a same source as the source 216 for the block of memory cells 250_{L}. For example, each block of memory cells 250₀-250_{L} can be commonly selectively connected to the source 216. Access lines 202 and select lines 214 and 215 of one block of memory cells 250 can have no direct connection to access lines 202 and select lines 214 and 215, respectively, of any other block of memory cells of the blocks of memory cells 250₀-250_{L}.

The bitlines 204₀-204_{M} can be connected (e.g., selectively connected) to a buffer portion 240, which can be a portion of the page buffer of the memory device 130. The buffer portion 240 can correspond to a memory plane (e.g., the set of blocks of memory cells 250₀-250_{L}). The buffer portion 240 can include sense circuits (which can include sense amplifiers) for sensing data values indicated on respective bitlines 204.

FIG. 2D is a diagram of a portion of an array of memory cells 200D (e.g., a portion of the array of memory cells 104). Channel regions (e.g., semiconductor pillars) 238₀₀ and 238₀₁ represent the channel regions of different strings of series-connected memory cells (e.g., strings 206 of FIGS. 2A-2C) selectively connected to the bitline 204₀. Similarly, channel regions 238₁₀ and 238₁₁ represent the channel regions of different strings of series-connected memory cells (e.g., NAND strings 206 of FIGS. 2A-2C) selectively connected to the bitline 204₁. A memory cell (not depicted in FIG. 2D) may be formed at each intersection of a wordline 202 and a channel region 238, and the memory cells corresponding to a single channel region 238 may collectively form a string of series-connected memory cells (e.g., a string 206 of FIGS. 2A-2C). Additional features might be common in such structures, such as dummy wordlines, segmented channel regions with interposed conductive regions, etc.

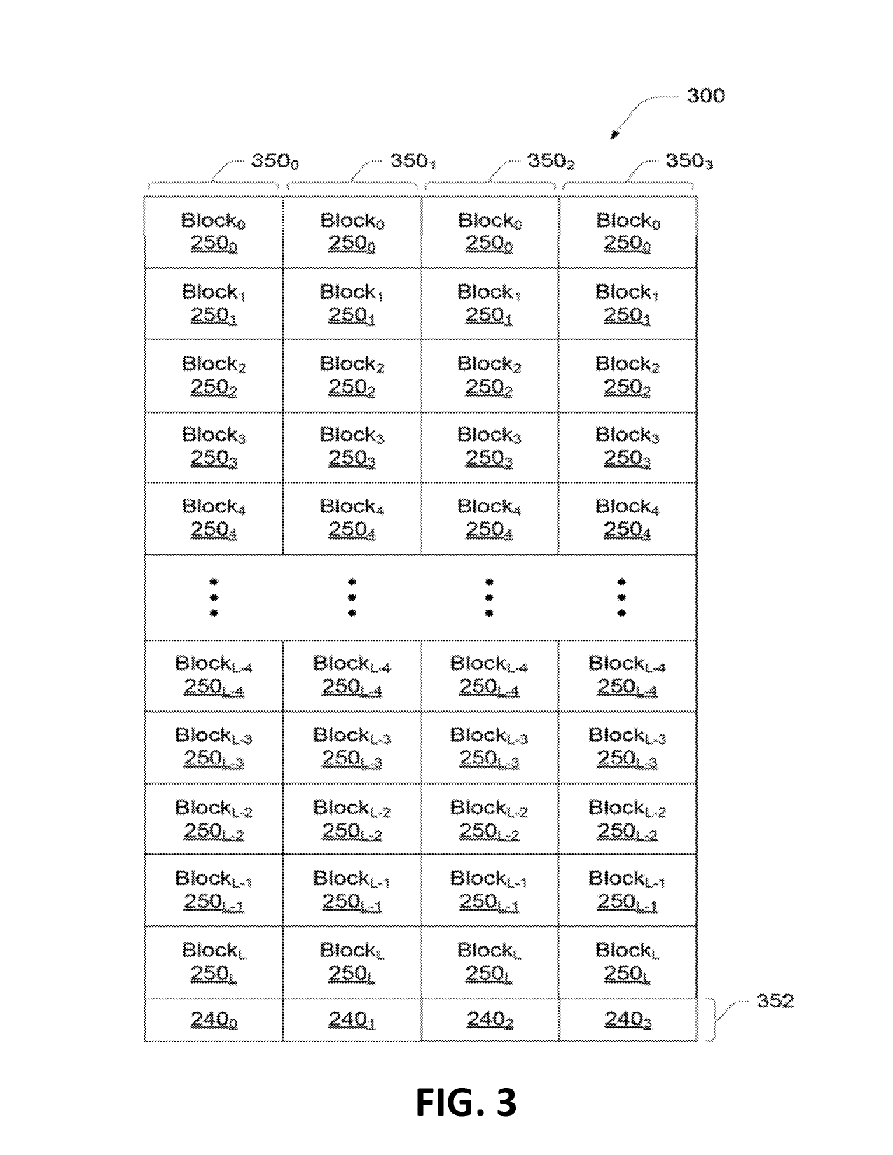

FIG. 3 is a block schematic of a portion of an array of memory cells 300 as could be used in a memory of the type described with reference to FIG. 1B. The array of memory cells 300 is depicted as having four memory planes 350 (e.g., memory planes 350₀-350₃), each in communication with a respective buffer portion 240, which can collectively form a page buffer 321. While four memory planes 350 are depicted, other numbers of memory planes 350 can be commonly in communication with a page buffer 352. Each memory plane 350 is depicted to include L+1 blocks of memory cells 250 (e.g., blocks of memory cells 250₀-250_{L}).

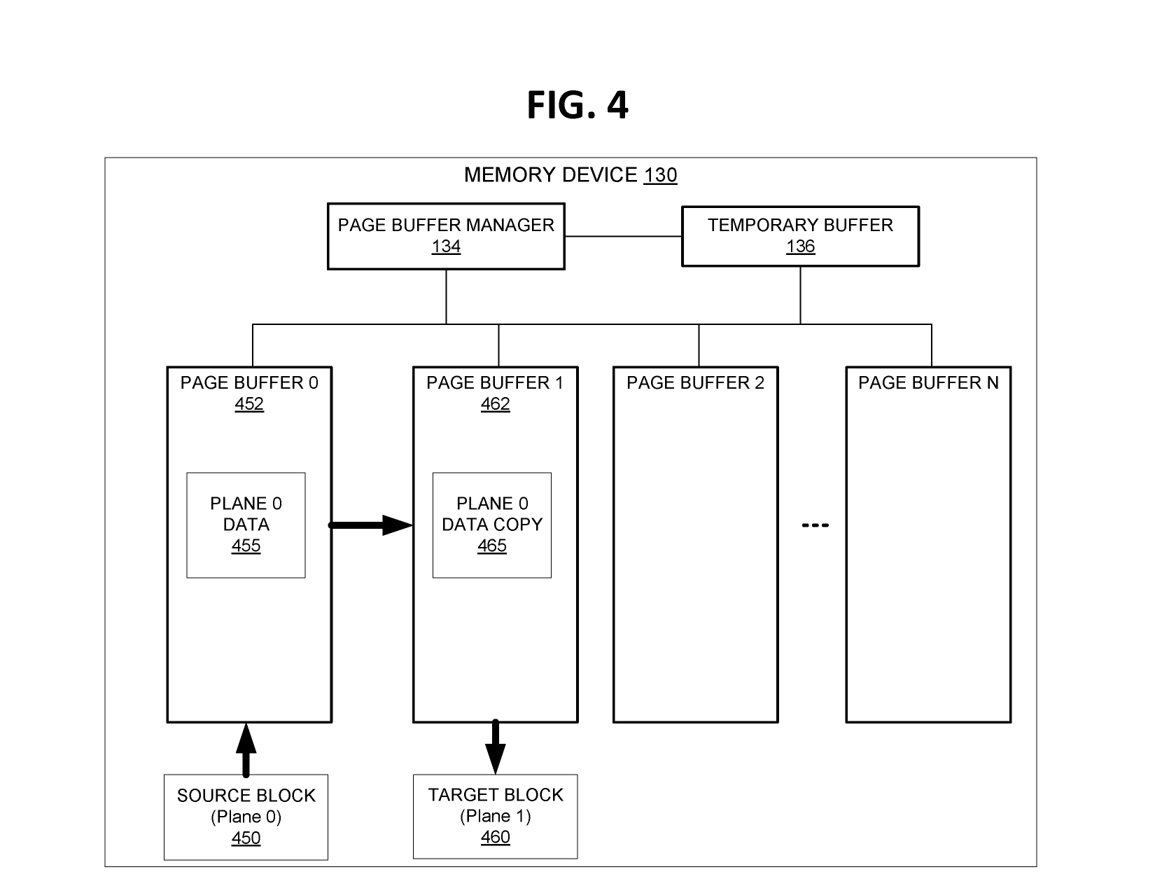

FIG. 4 illustrates an example memory device 130 including a page buffer manager 134 configured to manage the transfer of data associated with a first page buffer 452 associated with a first memory plane (e.g., plane 0) to a second page buffer 462 associated with a second memory plane (e.g., plane 1) of a multi-plane memory device, according to an embodiment. As shown in FIG. 4, the memory device 130 includes multiple page buffers (e.g., page buffer 0, page buffer 1, page buffer 2…page buffer N) each corresponding to a respective memory planes (e.g., Plane 0, Plane 1, Plane 2…Plane N). In an example, a first page buffer 452 (e.g., page buffer 0) store plane 0 data 455 associated with a source block 450 of plane 0.

In an embodiment, the page buffer manager 134 initiates an operation (also referred to as a “cross-plane data transfer operation”) to generate a backup or copy of plane 0 data 455 to be stored in a target block 460 of a different plane (e.g., plane 1). In an embodiment, the cross-plane data operation includes the execution of a read operation to read the plane 0 data 455 from the first page buffer 452 (page buffer 0). In an embodiment, the plane 0 data 455 that is read from the first page buffer 452 may be stored in a temporary buffer 136 (e.g., an SRAM buffer) of the memory device 130. In this embodiment, the page buffer manager 134 executes a write operation to write the plane 0 data 455 to the second page buffer 462 (e.g., page buffer 1) associated with a target memory block 460 of a second plane (e.g., Plane 1). In an embodiment, the plane 0 data 455 that is read from the first page buffer 452 is directly written to the second page buffer 462 of the memory device. In an embodiment, the plane 0 data 455 may be written from the temporary buffer 136 to the second page buffer 462.

In an embodiment, the writing of the data to the second page buffer 462 results in the storing of a copy or backup of the plane 0 data 465 in the second page buffer 462. It is noted that although the plane data copy transfer is illustrated in FIG. 4 between page buffer 0 and page buffer 1, embodiments of the present disclosure include the transfer of plane data copies between any of the page buffers of the memory device 130 (e.g., page buffer 0, page buffer 1, page buffer 2…page buffer N). In an embodiment, a copy of the plane data (e.g., plane 0 data 455) may be transferred to multiple different additional page buffers associated with multiple other memory planes.

Advantageously, the page buffer manager 134 executes the cross-plane data transfer operation to enable the internal transfer (i.e., within the memory device 130) of a copy of data (e.g., plane 0 data 450) from a first page buffer (e.g., page buffer 0) corresponding to a first memory plane (e.g., plane 0) to a second page buffer (e.g., page buffer 1) corresponding to a different memory plane (e.g., plane 1). In an embodiment, the plane 0 data copy 465 can then be written from the page buffer 1 to a target memory block 460 of a target plane (e.g., plane 1). As illustrated in FIG. 4, the data copy is transferred from a first (source) memory plane (plane 0) to a second (target)( memory plane (plane 1) via the execution of the cross-plane data transfer operation by the page buffer manager 134.

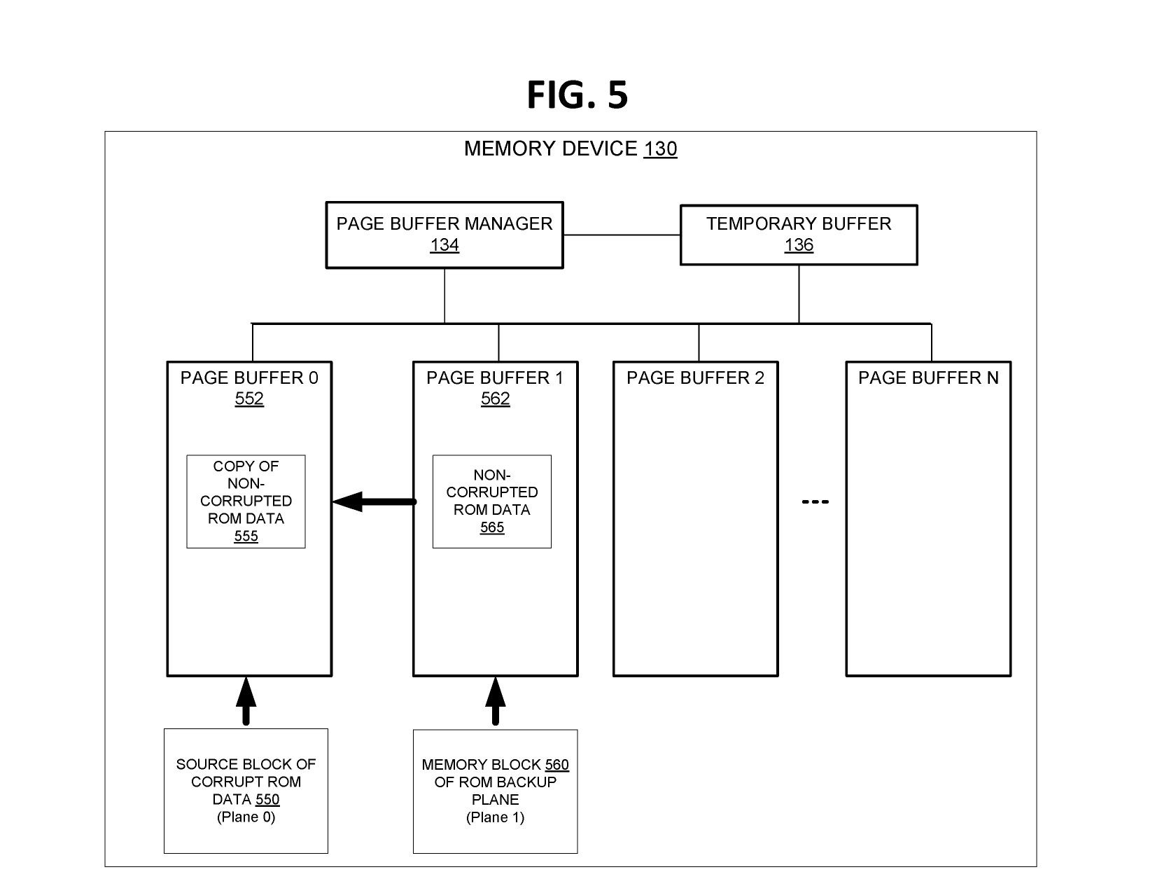

FIG. 5 illustrates an example memory device 130 including a page buffer manager 134 configured to manage the transfer of a copy of “good” or non-corrupted read-only memory (ROM) data from a page buffer (e.g., page puffer 1) associated with a memory block of a ROM backup plane memory block 560 of a ROM data backup plane (e.g., plane 1) to a page buffer (e.g., page buffer 0) associated with a memory block 550 of a plane (e.g., plane 0) that is the source of corrupt ROM data, according to an embodiment.

In an embodiment, the page buffer manager 134 identifies that a primary source block 550 that provides ROM data (e.g., for use in a power-up operation) contains corrupted or “bad” ROM data. In an example, during a power-up event associated with the memory device 130, ROM data may be used to perform the power-up reliably. In some cases, the ROM data maintained in the source block 550 of a first memory plane (e.g., plane 0) that is stored in the corresponding page buffer 560 to enable the execution of a power-up event is determined to be corrupt. In an embodiment, the ROM data stored in the source block 550 may be determined to be corrupt by determining a condition is satisfied. In an embodiment, the condition is satisfied if a bad or corrupted portion of the ROM data of the source block 550 is greater than a threshold level of bad data.

In an embodiment, if the page buffer manager 134 determines that the condition is satisfied (i.e., the source block 550 contains bad or corrupted data), the page buffer manager 134 initiates execution of ROM data correction operation. In an embodiment, the ROM data correction operation includes the execution of a read operation to read “good” or non-corrupted data from a page buffer 562 (e.g., page buffer 1) associated with a memory block 560 of a ROM backup plane (e.g., plane 1) to a temporary buffer 136 of the memory device 130. In an embodiment, in response to a command to execute a power-up event (or a retry event), the page buffer manager 134 reads the non-corrupted ROM data 565 (from the ROM backup plane) from a corresponding page buffer (e.g., page buffer 1). In an embodiment, the page buffer manager 134 may cause the non-corrupted ROM data 565 read from page buffer 1 to be stored in a temporary buffer 136 of the memory device 130. In this embodiment, the ROM data correction operation includes the execution of a write operation to write the non-corrupted ROM data 565 to another page buffer 552 (e.g., page buffer 0), such that a copy of the non-corrupted ROM data 555 is stored in the target page buffer 552 (e.g., page buffer 0) for use in executing the power-up (or retry) event. In an embodiment, the non-corrupted ROM data 565 is written directly from page buffer 1 to page buffer 0, or the non-corrupted ROM data 565 is written from the temporary buffer 136 to page buffer 0. Advantageously, execution of the cross-plane ROM data transfer by the page buffer manager 134 enables the reliable execution of the power-up (or retry) event using good or non-corrupted ROM data (e.g., the copy of the non-corrupted ROM data 555 that is transferred to page buffer 0).

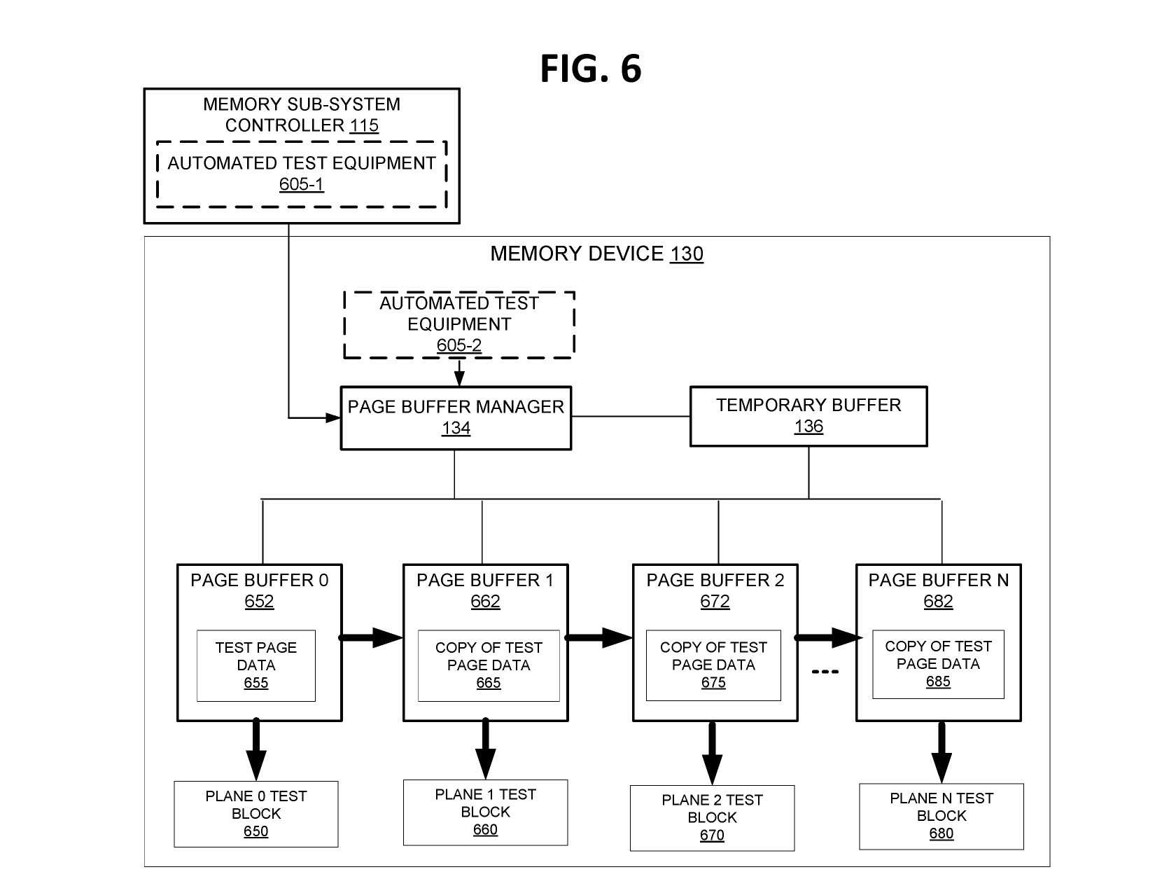

FIG. 6 illustrates an example memory device 130 including a page buffer manager 134 configured to manage the transfer of one or more copies of test data (e.g. data generated by automated test equipment 605-1, 605-2) from a first page buffer 652 (e.g., page buffer 0) to one or more other page buffers 662, 672, 682 (e.g., page buffer 1, page buffer 2 … page buffer N), according to an embodiment. In an embodiment, one or more automated test equipment generate test data (e.g., test page data) to be stored in a target memory block (e.g., plane 0 test block 650). In an example, the automated test equipment 605-1 may be a portion of a memory sub-system controller 115. In another example, the automated test equipment 605-2 may be a portion of the memory device 130 (e.g., a local media controller).

According to embodiments, the test page data 655 generated by the automated test is stored in a first page buffer 652 (e.g., page buffer 0) to be written to a first plane test block 650 (e.g., plane 0 test block). In an embodiment, the page buffer manager 134 executes a test data transfer operation to transfer a copy of the test page data 655 to one or more other page buffers of the memory device 130. In an embodiment, the test data transfer operation includes a read operation to read the test page data 655 from the first page buffer 652 (e.g., page buffer 0). In an embodiment, the test data transfer operation includes a write operation to temporarily store the test page data 655 to a temporary buffer 136 of the memory device 130.

In an embodiment, the page buffer manager 134 identifies one or more test blocks of other planes (e.g., plane 1 test block 660, plane 2 test block 670, and plane N test block 680) to store a copy of the test page data 655. In an embodiment, the test data transfer operation includes one or more write operations to write the one or more copies of the test page data 665, 675, 685 to the respective page buffers 662, 672, 682 (e.g., page buffer 1, page buffer 2, page buffer N) corresponding to the one or more target test blocks (e.g., plane 1 test block 660, plane 2 test block 670, plane N text block 680). In an embodiment, the one or more copies of the test page data 665,l 675, 685 are written directly from the first page buffer 652 to the one or more other page buffers 662, 672, 682. In an embodiment, the one or more copies of the test page data 665,l 675, 685 are written from the temporary buffer 136 to the one or more other page buffers 662, 672, 682.

According to embodiments, the page buffer manager 134 executes the test page data transfer operation to transfer one or more respective copies of the test page data 665, 675, 685 from one page buffer (e.g. page buffer 0) to one or more additional page buffers (e.g. page buffer 1, page buffer 2, page buffer N). According to embodiments, one or more write operations can be performed to write the copy of the test page data to a corresponding test block of a different plane. Accordingly, in the example shown in FIG. 6, the test data is written to plane 0 test block 650, and following the cross-plane test data duplication process, copies of the test data are written to plane 1 test block 660, plane 2 test block 670, and plane N test block 680. Advantageously, the cross-plane test data transfer operation enables the same test data to be copied to other planes, while avoiding the need for separate rewrites of the same test data from the automated test equipment to the respective page buffers.

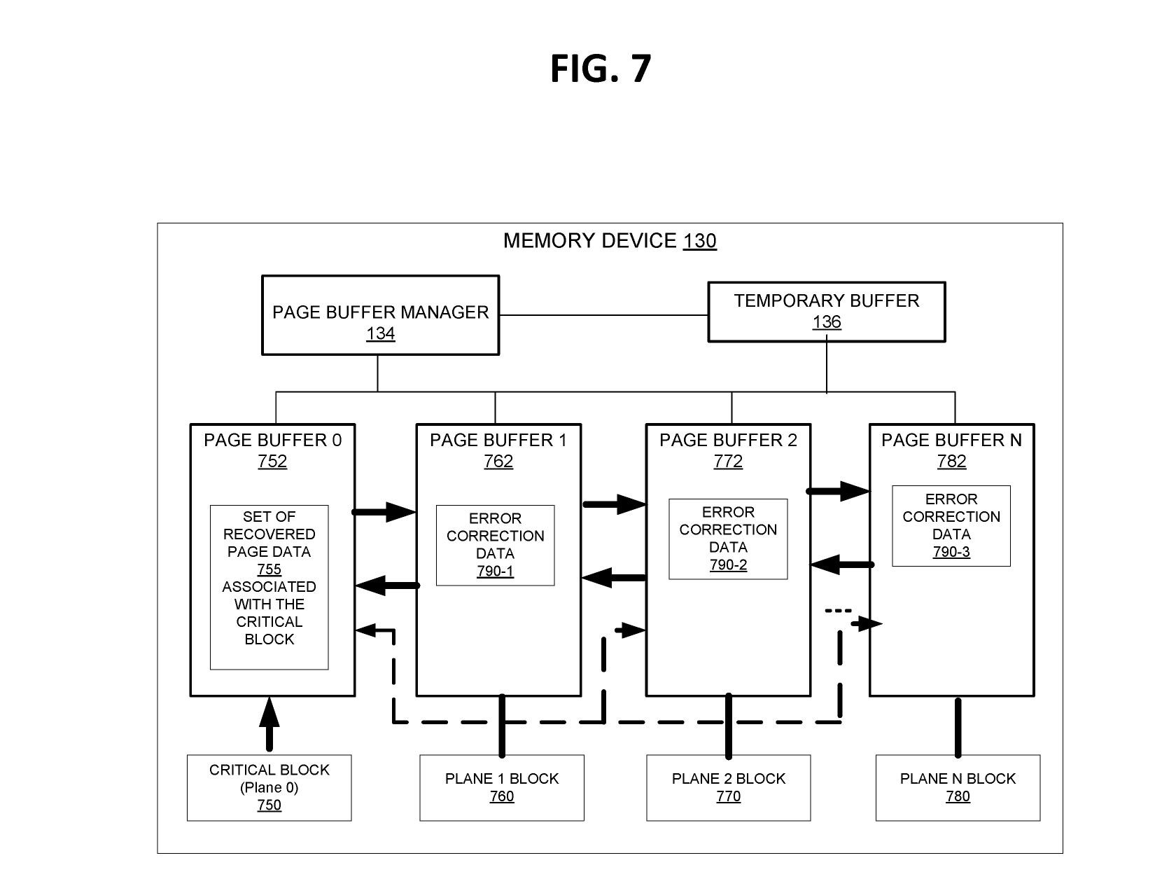

FIG. 7 illustrates an example memory device 130 including a page buffer manager 134 configured to manage the transfer of error correction data generated by an error correction algorithm (e.g., an error correction code (ECC) algorithm) from one or more page buffers to one or more other page buffers of the memory device 130, according to an embodiment. In an embodiment, an error correction algorithm or process is executed to correct data associated with a critical block 750 of a corresponding plane (e.g., plane 0). In an embodiment, the page buffer manager 134 causes data associated with the error correction algorithm (referred to herein as error correction data) to be stored in one or more page buffers 762, 772, 782 (e.g., page buffer 1, page buffer 2, page buffer N).

In an embodiment, the error recovery operation is executed to generate a set of recovered page data 755 associated with the critical block 750. In an embodiment, the page buffer manager 134 can cause error correction data to be stored in one or more page buffers 762, 772, 782 (e.g., page buffer 1, page buffer 2, page buffer N), and the transfer of the error correction data to a page buffer 752 associated with critical block (e.g., page buffer 0). Advantageously, the error correction data 790-1, 790-2, 790-3 (stored in respective page buffers) can be transferred to the page buffer associated with the critical block to enable the generation of the set of recovered page data 755.

In an embodiment, the page buffer manager 134 can cause the transfer of the set of recovered page data 755 to one or more of the other page buffers (e.g., page buffer 1, page buffer 2, page buffer N) for use in generating the error correction data. For example, the error correction data 790-1 may be generated based on one or more portions of the set of recovered page data.

According to embodiments, the page buffer manager 134 executes a critical data recovery operation which includes a read operation to read error correction data (e.g., error correction data 790-1, 790-2, 790-3) from a corresponding page buffer (e.g., page buffer 1, page buffer 2, page buffer N) to the page buffer 752 associated with the critical block (e.g., page buffer 0). In an embodiment, the error correction data that is read from the one or more page buffers may be stored in a temporary buffer 136 of the memory device 130. In this embodiment, the critical data recovery operation includes a write operation to write the data stored in the temporary buffer 136 (e.g., the error recovery data) to the page buffer 752 associated with the critical block (e.g., page buffer 0).

In an embodiment, the critical data recovery operation includes a read operation to read at least a portion of the recovered page data 755 from the page buffer 752 associated with the critical block 750. The critical data recovery operation further includes a write operation to write the at least the portion of the recovered page data 755. In an embodiment, the at least the of the recovered page data 755 that is read from the page buffer 752 is written directly to the one or more other page buffers (e.g., page buffer 1, page buffer 2, page buffer N) for use in the generating of error correction data (e.g., error correction data 790-1, 790-2, 790-3). In an embodiment, the at least the portion of the recovered page data 755 is read from the page buffer 752, stored in the temporary buffer 136, and written from the temporary buffer 136 to the one or more other page buffers (e.g., page buffer 1, page buffer 2, page buffer N) for use in the generating of error correction data (e.g., error correction data 790-1, 790-2, 790-3).

Advantageously, the page buffer manager 134 can cause data associated with the error correction process to be stored in multiple different page buffers. Accordingly, more complex error correction algorithms can be executed to generate additional error correction data to improve the recovery of critical page data in a memory device.

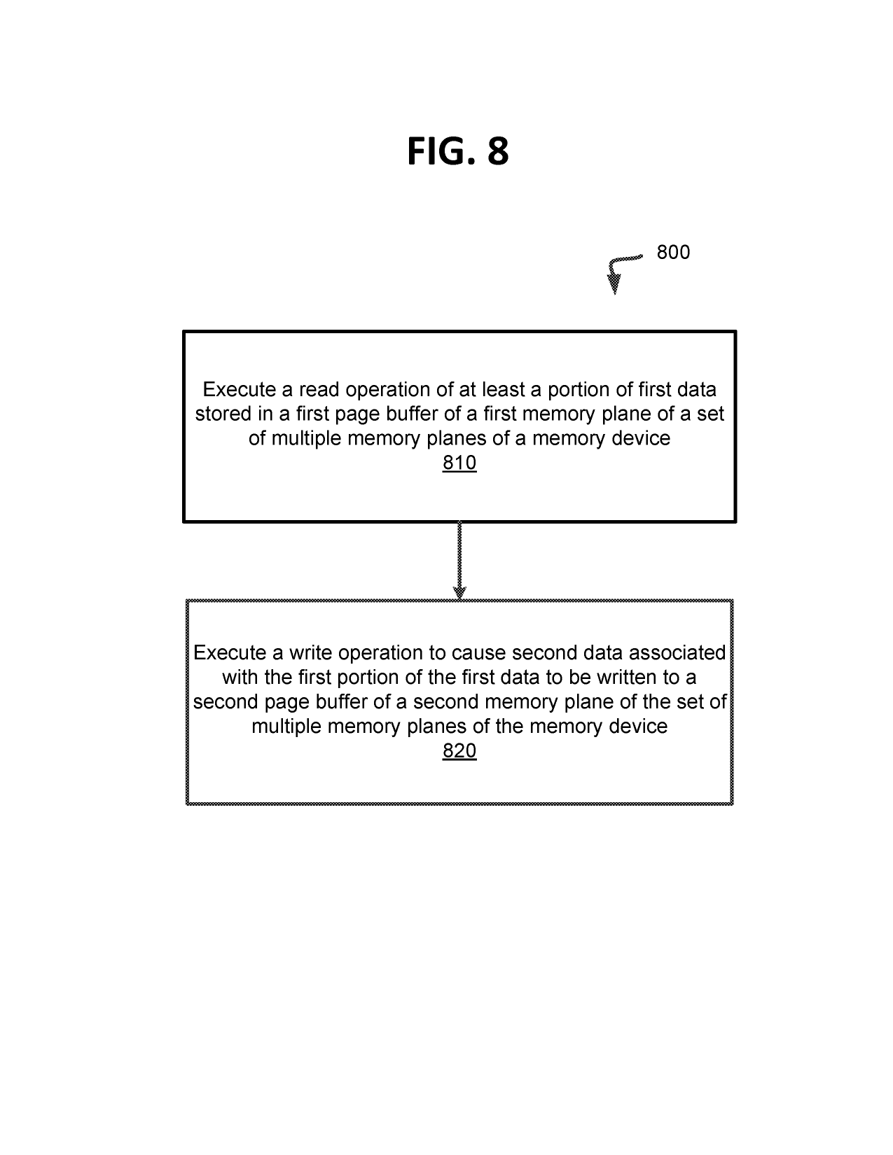

FIG. 8 is a flow diagram of an example method 800 to execute a ganged memory access operation associated with a memory device in a memory sub-system in accordance with some embodiments of the present disclosure. The method 800 is described with reference to FIGS. 1A-7. The method 800 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 800 is performed by page buffer manager 134 of FIGS. 1A, 1B, 4, 5, 6, and 7. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 810, an operation is executed. For example, control logic (e.g., page buffer manager 134) can execute a read operation to read at least a portion of first data stored in a first page buffer of a first memory plane of a set of multiple memory planes of a memory device. In an embodiment, the memory device includes a set of multiple page buffers (e.g., page buffer 0 to page buffer N, as shown in FIGS. 4-7), where each page buffer is associated with a corresponding memory plane (e.g., plane 0 to plane N, as shown in FIGS. 4-7). In the examples shown in FIGS. 4, 6, and 7, the first page buffer (page buffer 0) is associated with the first memory plane (e.g., plane 0) and stores the first data associated with the first memory plane. In the examples shown in FIG. 5, the first page buffer (page buffer 1) is associated with the first memory plane (e.g., plane 1) and stores the first data associated with the first memory plane.

In the example shown in FIG. 4, the first data includes plane 0 data associated with a source memory block of the first memory plane (plane 0). In the example shown in FIG. 5, the first data includes good or non-corrupted ROM data generated by a back-up ROM memory block of the first memory plane (plane 1). In the example shown in FIG. 6, the first data includes test page data generated by automated test equipment that is to be written to a memory block of the first memory plane (plane 0). In the example shown in FIG. 7, the first data includes data associated with a critical or corrupted memory block of the first memory plane (plane 0) that is to be recovered using an error correction algorithm.

In an embodiment, the control logic can cause the at least the portion of the first data to be stored in a temporary buffer (e.g., an SRAM buffer) of the memory device. In an embodiment, the at least the portion of the first data that is read from the first memory plane (e.g., plane 0 in FIGS. 4-7) is stored in the temporary buffer (e.g., temporary buffer 136 of FIGS. 4-7) of the memory device, prior to the execution of operation 820.

At operation 820, an operation is executed. For example, the control logic can execute a write operation to cause second data associated with the first portion of the first data to be written to a second page buffer of a second memory plane of the set of multiple memory planes of the memory device. As shown in FIGS. 4-7, the second page buffer (e.g., page buffer 1) is associated with the second memory plane (e.g., plane 1). In the example shown in FIG. 4, the second data includes a copy of the first portion of the first data that is to be written to a target memory block of the second memory plane (plane 1). In the example shown in FIG. 5, the second data includes a copy of the good or non-corrupted ROM data generated by the ROM backup memory block of the first memory plane (plane 0) that is transferred to the second page buffer (page buffer 0 in FIG. 5) that is associated with a bad or corrupted ROM block of the second memory plane (plane 0 in FIG. 5). In the example shown in FIG. 6, the second data includes a copy of the test page data that is to be written to a test memory block of the second memory plane (plane 1). In the example shown in FIG. 7, the second data includes error correction data generated using an error correction algorithm based on the data associated with the critical block of the first memory plane (plane 0 in FIG. 7). In an embodiment, the second data may be stored in the temporary buffer (e.g., an SRAM buffer) of the memory device, from which the second data is written to the second page buffer of the memory device.

According to embodiments, as a result of the operations of FIG. 8 (810-820), the control logic of the memory device executes the transfer of data from a first page buffer associated with a first memory plane to a second page buffer associated with a second memory plane. Advantageously, the cross-plane data buffer transfer is performed internally within the memory device, to reduce or eliminate the need for external storage to backup and rewrite page data across different memory planes of a multi-plane memory device.

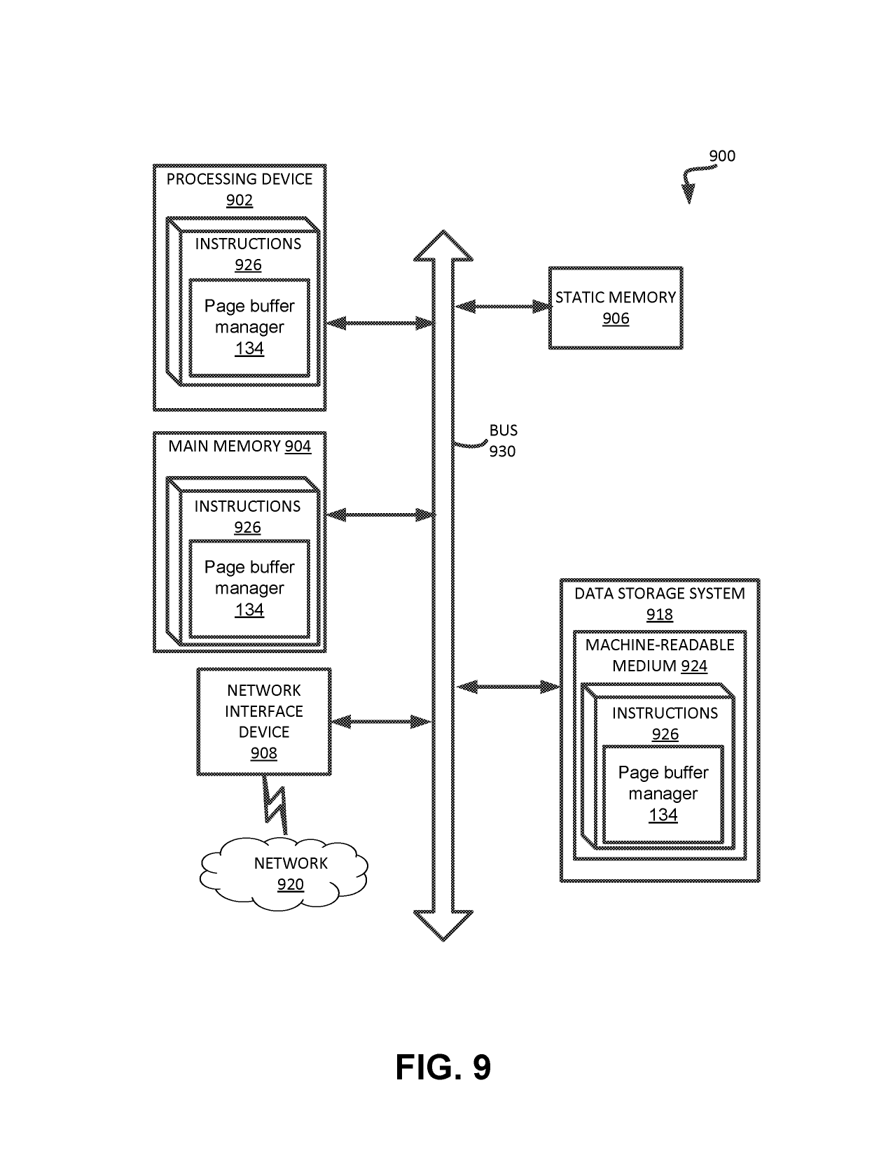

FIG. 9 illustrates an example machine of a computer system 900 within which a set of instructions, for causing the machine to perform any one or more of the methodologies discussed herein, can be executed. In some embodiments, the computer system 900 can correspond to a host system (e.g., the host system 120 of FIG. 1A) that includes, is coupled to, or utilizes a memory sub-system (e.g., the memory sub-system 110 of FIG. 1A) or can be used to perform the operations of a controller (e.g., to execute an operating system to perform operations corresponding to page buffer manager 134 of FIGS. 1A and 1B). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 900 includes a processing device 902, a main memory 904 (e.g., read-only memory (ROM), flash memory, dynamic random access memory (DRAM) such as synchronous DRAM (SDRAM) or Rambus DRAM (RDRAM), etc.), a static memory 906 (e.g., flash memory, static random access memory (SRAM), etc.), and a data storage system 918, which communicate with each other via a bus 930.

Processing device 902 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 902 can also be one or more special-purpose processing devices such as an application specific integrated circuit (ASIC), a field programmable gate array (FPGA), a digital signal processor (DSP), network processor, or the like. The processing device 902 is configured to execute instructions 926 for performing the operations and steps discussed herein. The computer system 900 can further include a network interface device 908 to communicate over the network 920.

The data storage system 918 can include a machine-readable storage medium 924 (also known as a computer-readable medium, such as a non-transitory computer-readable medium) on which is stored one or more sets of instructions 926 or software embodying any one or more of the methodologies or functions described herein. The instructions 926 can also reside, completely or at least partially, within the main memory 904 and/or within the processing device 902 during execution thereof by the computer system 900, the main memory 904 and the processing device 902 also constituting machine-readable storage media. The machine-readable storage medium 924, data storage system 918, and/or main memory 904 can correspond to the memory sub-system 110 of FIG. 1A.

In one embodiment, the instructions 926 include instructions to implement functionality corresponding to page buffer manager 134 of FIGS. 1A and 1B). While the machine-readable storage medium 924 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A memory device comprising:
a memory array;
a plurality of page buffers comprising a first page buffer associated with a first memory plane of the memory array and a second page buffer associated with a second memory plane of the memory array; and
control logic, operatively coupled to the plurality of page buffers, to perform operations comprising:
executing a read operation of at least a portion of first data stored in the first page buffer associated with the first memory plane of the memory array; and
executing a write operation to cause second data associated with the at least a portion of the first data to be written to the second page buffer of the memory device.

2. The memory device of claim 1, wherein the portion of the first data stored in the first page buffer is stored in a temporary buffer of the memory device prior to being written to the second page buffer.

3. The memory device of claim 1, wherein the portion of the first data comprises data written to a source memory block of the first memory plane; and wherein the second data comprises a copy of the portion of the first data.

4. The memory device of claim 3, wherein the control logic is to perform operations further comprising programming the second data to a target memory block of the second memory plane.

5. The memory device of claim 1, wherein the first data comprises non-corrupted read only memory (ROM) data generated by a backup ROM memory block of the first memory plane, and wherein the second data comprises a copy of the non-corrupted ROM data.

6. The memory device of claim 1, wherein the first data comprises test page data generated by automated test equipment, and wherein the second data comprises a copy of the test page data.

7. The memory device of claim 1, wherein the second data comprises error correction data generated by an error correction algorithm based at least in part on the portion of the first data.

8. A method comprising:
executing a read operation of at least a portion of first data stored in a first page buffer associated with a first memory plane of a plurality of memory planes of a memory device; and
executing a write operation to cause second data associated with the at least the portion of the first data to be written to a second page buffer associated with a second memory plane of the memory device.

9. The method of claim 8, wherein the portion of the first data stored in the first page buffer is stored in a temporary buffer of the memory device prior to being written to the second page buffer.

10. The method of claim 8, wherein the portion of the first data comprises data written to a source memory block of the first memory plane; and wherein the second data comprises a copy of the portion of the first data.

11. The method of claim 10, further comprising programming the second data to a target memory block of the second memory plane.

12. The method of claim 8, wherein the first data comprises non-corrupted read only memory (ROM) data generated by a backup ROM memory block of the first memory plane; and wherein the second data comprises a copy of the non-corrupted ROM data.

13. The method of claim 8, wherein the first data comprises test page data generated by automated test equipment; and wherein the second data comprises a copy of the test page data.

14. The method of claim 8, wherein the second data comprises error correction data generated by an error correction algorithm based at least in part on the at least the portion of the first data.

15. A memory device comprising:
a memory array;
a plurality of page buffers comprising a first page buffer associated with a first memory plane of the memory array and a second page buffer associated with a second memory plane of the memory array; and
control logic, operatively coupled to the plurality of page buffers, to perform operations comprising:
identifying a critical memory block of the first memory plane comprising corrupted data;
executing an error correction algorithm to generate error correction data;
storing the error correction data in the second page buffer; and
causing a transfer of at least a portion of the error correction data from the second page buffer to the first page buffer.

16. The memory device of claim 15, wherein the control logic is to perform operations further comprising executing a read operation of the portion of the error correction data stored in the second page buffer.

17. The memory device of claim 16, wherein the control logic is to perform operations further comprising causing the portion of the second data to be stored in a static random-access memory (SRAM) buffer of the memory device.

18. The memory device of claim 17, wherein the control logic is to perform operations further comprising executing a write operation to cause the portion of the second data to be written from the SRAM buffer to the first page buffer associated with the first memory plane comprising the critical memory block.

19. The memory device of claim 15, wherein recovered page data associated with the critical memory block is generated based at least in part on the portion of the second data.

20. The memory device of claim 19, wherein the recovered page data is stored in the first page buffer associated with the first memory plane comprising the critical memory block.
